(19) United States
(12) Patent Application Publication
(10) Pub. No.: US 2014/0271025 A1
(43) Pub. Date: Sep. 18, 2014

(54) SNAP-ENGAGEMENT MODULE AND JOINTING MODULE

(71) Applicant: FIVETECH TECHNOLOGY INC., NEW TAIPEI CITY (TW)

(72) Inventor: TING-JUI WANG, NEW TAIPEI CITY (TW)

(73) Assignee: FIVETECH TECHNOLOGY INC., NEW TAIPEI CITY (TW)

(21) Appl. No.: 13/833,825

(22) Filed: Mar. 15, 2013

(51) Int. Cl. F16B 21/07

(52) U.S. Cl. CPC F16B 21/07
USPC 411/44

(57) ABSTRACT

A snap-engagement module includes a fixing portion, support, extension portion, snap-engagement portion, and prodding portion. A first jointing unit of the fixing portion and a jointing hole of the support are jointed. The extension portion connects to the first jointing unit. A passage is formed inside the fixing portion and the extension portion. The snap-engagement portion is movably disposed at the extension portion. The prodding portion has a controlling unit connected to the prodding unit and exposed from the fixing portion. The prodding unit is movably disposed at the passage to retract or protrude the snap-engagement portion. A jointing module comprises a jointing base and a jointing ring. The jointing base has a second jointing unit, a jointing hole, and a receiving space. The jointing ring is movably confined to the receiving space. The snap-engagement portion snap-engages the jointing ring.

### FIELD OF TECHNOLOGY

The present invention relates to snap-engagement modules and jointing modules, and more particularly, to modules equipped with a snap-engagement portion and a jointing ring and adapted for snap-engagement.

### BACKGROUND

A screw and a nut are conventional tools for fixing two objects to each other. A typical procedure for manipulating the conventional screw and nut involves drilling an opening on each of the two objects, passing the screw through the openings of the two objects, pre-screwing the nut until the nut meshes with the thread of the screw, holding the nut in place with a wrench, and turning the screw with another wrench until two objects are fixed to each other by means of the screw and the nut. However, it is necessary to hold the screw and the nut firmly while the nut is being pre-screwed to mesh with the thread of the screw. Furthermore, two objects cannot be fixed to each other with the screw and the nut without rotating the wrench by several revolutions, and it is time-consuming and laborious to do so. Last but not least, to separate the two objects, it is necessary to hold the screw and turn the nut by several revolutions with the two wrenches, respectively, and, needless to say, it is time-consuming and laborious to do so.

Accordingly, it is imperative to devise a jointing module for jointing/separating two objects quickly and conveniently.

### SUMMARY

In view of the aforesaid drawbacks of the prior art, the inventor of the present invention conceived room for improvement in the prior art and thus conducted extensive researches and experiments according to the inventor's years of experience in the related industry, and finally developed a snap-engagement module and a jointing module as disclosed in the present invention to ensure that two objects can be jointed or separated quickly and conveniently.

In order to achieve the above and other objectives, in the first embodiment of the present invention, a snap-engagement module comprises: a fixing portion having a first jointing unit; a support having a jointing hole, wherein the first jointing unit joining the jointing hole; an extension portion connected to the first jointing unit, wherein a passage is formed inside the fixing portion and the extension portion; a snap-engagement portion movably disposed at the extension portion; and a prodding portion having a controlling unit and a prodding unit connected together, the controlling unit protruding from the fixing portion, the prodding unit being movably disposed at the passage and the snap-engagement portion to retract or protrude the snap-engagement portion.

In the second embodiment of the present invention, a jointing module jointed to the snap-engagement module is provided. The jointing module comprises: a jointing base having a second jointing unit, at least one jointing hole, and a receiving space being in communication with the jointing hole; and a jointing ring movably confined to the receiving space and centrally communicating with the jointing hole, wherein a snap-engagement portion of the snap-engagement module snap-engages the jointing ring.

Therefore, the snap-engagement module and the jointing module of the present invention enables two objects to be jointed or separated quickly and conveniently.

### BRIEF DESCRIPTION OF THE DRAWINGS

Objectives, features, and advantages of the present invention are hereunder illustrated with specific embodiments in conjunction with the accompanying drawings, in which:

FIG. 1 is schematic view 1 of a snap-engagement module according to the present invention;

FIG. 2 is schematic view 2 of the snap-engagement module according to the present invention;

FIG. 3 is schematic view 1 of the snap-engagement module which has not jointed two objects yet according to the present invention;

FIG. 4 is schematic view 1 of the snap-engagement module which has jointed the two objects according to the present invention;

FIG. 5 is schematic view 2 of the snap-engagement module which has not jointed two objects yet according to the present invention;

FIG. 6 is schematic view 2 of the snap-engagement module which has jointed the two objects according to the present invention;

FIG. 7 is schematic view 3 of the snap-engagement module according to the present invention;

FIG. 8 is schematic view 4 of the snap-engagement module according to the present invention;

FIGS. 9(a)-9(c) are schematic views of a first jointing unit of a fixing portion according to the present invention;

FIG. 10 is a schematic view of a jointing module according to the present invention;

FIG. 11 is a bottom view of the jointing module according to the present invention;

FIGS. 12(a)-12(c) are schematic views of second jointing units of the jointing module according to the present invention;

FIG. 13 is schematic view 1 of the snap-engagement module and the jointing module which have not yet been jointed together according to the present invention;

FIG. 14 is schematic view 1 of the snap-engagement module and the jointing module which have been jointed together according to the present invention;

FIG. 15 is schematic view 2 of the snap-engagement module and the jointing module which have not yet been jointed together according to the present invention;

FIG. 16 is schematic view 2 of the snap-engagement module and the jointing module which have been jointed together according to the present invention;

FIG. 17 is schematic view 5 of the snap-engagement module according to the present invention;

FIG. 18 is schematic view 6 of the snap-engagement module according to the present invention;

FIG. 19 is schematic view 7 of the snap-engagement module according to the present invention; and

FIG. 20 is schematic view 8 of the snap-engagement module according to the present invention.

### DETAILED DESCRIPTION

Referring to FIG. 1, there is shown schematic view 1 of a snap-engagement module according to the present invention. As shown in the diagram, in the first embodiment of the present invention, a snap-engagement module 1 comprises a fixing portion 11, a support 19, an extension portion 12, a snap-engagement portion 13, and a prodding portion 14. The fixing portion 11 has a first jointing unit 111 from below. The first jointing unit 111 has a laterally-facing jointing structure (such as a press-in structure) whereby the first jointing unit 111 and a jointing hole (not shown) of an object are jointed together. The fixing portion 11 further has a first stopping unit 112 positioned peripherally. As soon as the fixing portion 11 and the jointing hole of the object are jointed together by means of the first jointing unit 111, the first stopping unit 112 enables the fixing portion 11 to stop at the object and thus prevents the fixing portion 11 from lying overly deep in the object. The support 19 is L-shaped and consists of a long portion and a short portion. The long portion of the support 19 has a jointing hole 191. The first jointing unit 111 and the support 19 are jointed at the jointing hole 191. The short portion of the support 19 has a fixing hole 192. The support 19 can be fixed to an object (not shown) by means of the fixing hole 192 and a fixing element (not shown). If the support 19 does not have the fixing hole 192, the support 19 can still be fixed to the object by an adhesive or by welding. The support 19 is made of metal or plastic as needed. The extension portion 12 is connected to the first jointing unit 111 from below. A passage 15 is formed inside the fixing portion 11 and the extension portion 12 to enable internal communication between the fixing portion 11 and the extension portion 12. The snap-engagement portion 13 is movably disposed at an appropriate portion of the extension portion 12 and adapted to effectuate snap-engagement with another object (not shown). The prodding portion 14 has a controlling unit 141 and a prodding unit 142 coupled thereto. The controlling unit 141 protrudes from the fixing portion 11 to allow a user to operate the controlling unit 141 conveniently. The prodding unit 142 is rod-shaped and is movably disposed at the passage 15 and adapted to start/stop the snap-engagement effect of the snap-engagement portion 13. As soon as the user lifts the controlling unit 141, the controlling unit 141 drives the prodding unit 142 to move away from the snap-engagement portion 13 until the snap-engagement portion 13 is no longer in contact with the prodding unit 142. As soon as the user presses the controlling unit 141, the controlling unit 141 drives the prodding unit 142 to move closer to the snap-engagement portion 13 until the snap-engagement portion 13 comes into contact with the prodding unit 142.

Referring to FIG. 1, the extension portion 12 has at least one opening 121 in communication with the passage 15 and the outside, and the snap-engagement portion 13 has at least one snap-engagement ball 131. Preferably, the extension portion 12 has two said openings 121 each in communication with the passage 15 and the outside, whereas the snap-engagement portion 13 has two said snap-engagement balls 131, as shown in diagram. The diameter of the inner rim (i.e., the passage-facing rim) of each of the openings 121 is slightly less than that of the corresponding one of the snap-engagement balls 131. The diameter of the outer rim (i.e., the outside-facing rim) of each of the openings 121 is also slightly less than that of the corresponding one of the snap-engagement balls 131. Hence, the snap-engagement balls 131 are movably confined to the openings 121, respectively, whereas the prodding unit 142 is movably disposed between the snap-engagement balls 131. As soon as the user lifts the controlling unit 141, the controlling unit 141 drives the prodding unit 142 to move away from the snap-engagement balls 131, thereby allowing the snap-engagement balls 131 to retreat partially into the passage 15. As soon as the user presses the controlling unit 141, the controlling unit 141 drives the prodding unit 142 to move to the point between the snap-engagement balls 131, such that the snap-engagement balls 131 are pushed outward by the prodding unit 142 to thereby protrude partially from the extension portion 12.

Referring to FIG. 1, the snap-engagement module 1 further comprises a pointed or unpointed tapered aiming portion 16. The aiming portion 16 is connected to the extension portion 12 from below. To allow the snap-engagement module 1 to join a jointing hole (not shown) of an object, the aiming portion 16 is aimed at the jointing hole to guide the first jointing unit 111 of the snap-engagement module 1 in joining the jointing hole and thereby enhance the ease of jointing.

Referring to FIG. 2, there is shown schematic view 2 of the snap-engagement module according to the present invention. As shown in the diagram, a snap-engagement portion 13′ has at least one resilient engagement body 131′. Two resilient engagement bodies 131′ are shown in the diagram. The resilient engagement bodies 131′ are connected to the extension portion 12 from below. The prodding unit 142 is movably disposed between the resilient engagement bodies 131′. Therefore, as soon as the user lifts the controlling unit 141, the controlling unit 141 drives the prodding unit 142 to move away from the resilient engagement bodies 131′, and thus the resilient engagement bodies 131′ constrict inward. As soon as the user presses the controlling unit 141, the controlling unit 141 drives the prodding unit 142 into between the resilient engagement bodies 131′, such that the resilient engagement bodies 131′ are pushed outward by the prodding unit 142 and thereby cannot retract.

Referring to FIG. 3 through FIG. 6, there are shown schematic view 1 in which the snap-engagement module has not jointed two objects yet, schematic view 1 in which the snap-engagement module has jointed two objects, schematic view 2 in which the snap-engagement module has not jointed two objects yet, and schematic view 2 in which the snap-engagement module has jointed two objects, according to the present invention. As shown in the diagrams, to start operating the snap-engagement modules 1, 1′ shown in FIG. 1 and FIG. 2 according to the present invention, it is necessary to joint together a fixing element 5 (such as a screw), the fixing hole 192 of the support 19 of the snap-engagement modules 1, 1′, and a first jointing hole 31 of a first object 3, and then lift the controlling unit 141 of the prodding portion 14 to allow the prodding unit 142 of the prodding portion 14 to move away from the snap-engagement balls 131 and the resilient engagement bodies 131′ to thereby retract the snap-engagement balls 131 and the resilient engagement bodies 131′. Since the snap-engagement balls 131 can retreat into the extension portion 12, the resilient engagement bodies 131′ can retract and deform. Hence, the snap-engagement modules 1, 1′ pass through a second jointing hole 41 of a second object 4. Afterward, the user can press the controlling unit 141 of the prodding portion 14 to allow the prodding unit 142 of the prodding portion 14 to be positioned between the snap-engagement balls 131 and between the resilient engagement bodies 131′, so as to protrude the snap-engagement balls 131 and the resilient engagement bodies 131′. At this point in time, the snap-engagement balls 131 cannot retreat into the extension portion 12, and thus the resilient engagement bodies 131′ cannot retract and deform. Hence, the snap-engagement balls 131 and the resilient engagement bodies 131′ can snap-engage the second jointing hole 41 of the second object 4, such that the first object 3 and the second object 4 can be jointed together. To separate the first object 3 and the second object 4, all the user needs to do is to lift the controlling unit 141 of the prodding portion 14 again to retract the snap-engagement balls 131 and the resilient engagement bodies 131′.

As described above, with the snap-engagement module of the present invention, two objects can be jointed together or separated from each other quickly and conveniently.

Referring to FIG. 7 and FIG. 8, there are shown schematic views 3, 4 of the snap-engagement module according to the present invention. As shown in the diagrams, the snap-engagement module 1″ further comprises a grip-and-turn body 17. The grip-and-turn body 17 has a grip-and-turn handle 174, a first prodding edge 171, and a second prodding edge 172. The grip-and-turn body 17 is pivotally coupled to the controlling unit 141 to form a pivotal point 173. The first prodding edge 171 or the second prodding edge 172 protrudes the fixing portion 11. The distance between the pivotal point 173 and the first prodding edge 171 is larger than the distance between the pivotal point 173 and the second prodding edge 172. As soon as the user grips and turns up the grip-and-turn handle 174 of the grip-and-turn body 17, the grip-and-turn body 17 turns relative to the pivotal point 173. Then, the first prodding edge 171 protrudes the fixing portion 11. Due to the relatively long distance between the pivotal point 173 and the first prodding edge 171, the grip-and-turn body 17 lifts the controlling unit 141 of the prodding portion 14, and thus the controlling unit 141 drives the prodding unit 142 of the prodding portion 14 to move away from the snap-engagement balls 131. As a result, the snap-engagement balls 131 retract and retreat into the extension portion. As soon as the user grips and turns downward the grip-and-turn handle 174 of the grip-and-turn body 17, the grip-and-turn body 17 turns relative to the pivotal point 173. Then, the second prodding edge 172 protrudes the fixing portion 11. Due to the relatively short distance between the pivotal point 173 and the second prodding edge 172, the grip-and-turn body 17 presses the controlling unit 141 of the prodding portion 14, and thus the controlling unit 141 drives the prodding unit 142 of the prodding portion 14 to between the snap-engagement balls 131. As a result, the snap-engagement balls 131 are pushed by the prodding unit 142 to thereby protrude partially from the extension portion 12. Furthermore, FIG. 7 and FIG. 8 illustrate the way in which the grip-and-turn body 17 and the resilient element 18 operate in conjunction with the snap-engagement module 1 of FIG. 1. Likewise, the grip-and-turn body 17 and the resilient element 18 can also operate in conjunction with the snap-engagement module 1′ of FIG. 2. Furthermore, FIG. 3 through FIG. 6 illustrate the way in which two objects 3, 4 are jointed together by the snap-engagement module comprising the grip-and-turn body 17 and the resilient element 18.

Referring to FIG. 7 and FIG. 8, the snap-engagement module 1″ further comprises a resilient element 18. One end of the resilient element 18 abuts against the wall surface of the passage 15, such as a protrusion disposed inside the passage 15 and derived from the wall surface thereof. The other end of the resilient element 18 abuts against the prodding unit 142, such as a protrusion extending outward from the prodding unit 142. As soon as the user grips and turns upward the grip-and-turn handle 174 of the grip-and-turn body 17, the first prodding edge 171 starts to abut against the fixing portion 11, such that the resilient element 18 gets compressed. Due to the resilience energy stored in the resilient element 18 thus compressed, the snap-engagement module 1″ maintains its status quo as shown in FIG. 8. As soon as the user grips and turns downward the grip-and-turn handle 174 of the grip-and-turn body 17, the second prodding edge 172 starts abutting against the fixing portion 11, and thus the resilience energy stored in the resilient element 18 thus compressed gets released in part, whereas the unreleased portion of the resilience energy stored in the resilient element 18 maintains the status quo of the snap-engagement module 1″ as shown in FIG. 7.

Referring to FIG. 3 through FIG. 6, the controlling unit 141 is T-shaped and thus easy to be lifted or pressed by the user.

Referring to FIGS. 9(a)-9(c), there are shown schematic views of the first jointing unit 111 of the fixing portion 11 of the present invention. As shown in the diagrams, the first jointing unit 111 of the fixing portion 11 is a press-in structure. The first jointing units 111′, 111″, 111′″ are a screwing structure (as shown in FIG. 9 (a)), a fitting-extending structure (as shown in FIG. 9 (b)), a soldering structure, a welding structure (as shown in FIG. 9 (b)), an adhesive structure (as shown in FIG. 9 (b)), or a snap-engagement structure (as shown in FIG. 9 (c)).

Referring to FIG. 10, there is shown a schematic view of a jointing module according to the present invention. As shown in the diagram, in the second embodiment of the present invention, a jointing module 2 comprises a jointing base 21 and a jointing ring 22. The jointing base 21 has a second jointing unit 211, at least one jointing hole 212, and a receiving space 213. The receiving space 213 is in communication with the jointing hole 212. The second jointing unit 211 has a laterally-facing jointing structure (such as a press-in structure) whereby the second jointing unit 211 is jointed to a jointing hole (not shown) of an object. Furthermore, a second stopping unit 214 is disposed at the periphery of the jointing base 21. As soon as the second jointing unit 211 of the jointing base 21 is jointed to the jointing hole of the object, the second stopping unit 214 enables the jointing base 21 to stop at the object to thereby preventing the jointing base 21 from traveling too long a distance into the object. The jointing ring 22 is movably confined to the receiving space 213. The jointing ring 22 is centrally in communication with the jointing hole 212. Referring to FIG. 1, FIG. 2, and FIG. 7, the snap-engagement portions 13, 13′, 13″ of the snap-engagement modules 1, 1′, 1″ snap-engage the jointing ring 22 of the jointing module 2, respectively.

Referring to FIG. 11, there is shown a bottom view of the jointing module according to the present invention. As shown in the diagram, the jointing ring 22 is annular. The receiving space 213 has a round cross-sectional area corresponding in shape to the cross-sectional area of the jointing ring 22.

Referring to FIGS. 12(a)-12(c), there are shown schematic views of second jointing units of the jointing module according to the present invention. As shown in the diagrams, the second jointing unit 211 of the jointing base 21 is a press-in structure, wherein second jointing units 211′, 211″, 211′″ are a screwing structure (as shown in FIG. 12 (a)), a fitting-extending structure (as shown in FIG. 12 (b)), a soldering structure, a welding structure (as shown in FIG. 12 (b)), an adhesive structure (as shown in FIG. 12 (b)), or a snap-engagement structure (as shown in FIG. 12 (c)), respectively, as needed.

Referring to FIG. 10, the second jointing unit 211 is positioned at the periphery of the jointing hole 212.

FIG. 13 is schematic view 1 of the snap-engagement module and the jointing module which have not yet been jointed together according to the present invention. FIG. 14 is schematic view 1 of the snap-engagement module and the jointing module which have been jointed together according to the present invention. FIG. 15 is schematic view 2 of the snap-engagement module and the jointing module which have not yet been jointed together according to the present invention. FIG. 16 is schematic view 2 of the snap-engagement module and the jointing module which have been jointed together according to the present invention. As shown in the diagrams, to start manipulating the snap-engagement modules 1, 1′ in FIG. 1 and FIG. 2 and the jointing module 2 in FIG. 11, it is necessary for the first jointing hole 31 of the first object 3 to be jointed to a fixing element 5 (such as a screw) and the fixing hole 192 of the support 19 of the snap-engagement modules 1, 1′ and for the second jointing hole 41 of the second object 4 to be jointed to the second jointing unit 211 of the jointing module 2. Then, the user lifts the controlling unit 141 of the prodding portion 14, such that the controlling unit 141 drives the prodding unit 142 of the prodding portion 14 to move away from the snap-engagement balls 131 and the resilient engagement bodies 131′ to thereby retract the snap-engagement balls 131 and the resilient engagement bodies 131′. Since the snap-engagement balls 131 can retreat into the extension portion 12, the resilient engagement bodies 131′ can retract and deform; hence, the snap-engagement portion 13, 13′ of the snap-engagement modules 1, 1′ can pass through the jointing ring 22 of the jointing module 2. At this point in time, with the jointing ring 22 being movably confined to the receiving space 213, the jointing ring 22 can move laterally within the receiving space 213. If the snap-engagement portions 13, 13′ of the snap-engagement modules 1, 1′ are not aligned with the center of the jointing ring 22, the jointing ring 22 can move laterally to thereby align the snap-engagement portion 13, 13′ of the snap-engagement modules 1, 1′ with the center of the jointing ring 22, such that the snap-engagement portions 13, 13′ of the snap-engagement modules 1, 1′ pass through the jointing ring 22 of the jointing module 2. Afterward, the snap-engagement portions 13, 13′ of the snap-engagement modules 1, 1′ push the controlling unit 141 of the prodding portion 14 downward to cause the prodding unit 142 of the prodding portion 141 to end up between the snap-engagement balls 131 and between the resilient engagement bodies 131′ to thereby protrudes the snap-engagement balls 131 and the resilient engagement bodies 131′. Since the snap-engagement balls 131 cannot retreat into the extension portion 12, the resilient engagement bodies 131′ cannot retract and deform. Hence, the snap-engagement balls 131 and the resilient engagement bodies 131′ snap-engage the jointing ring 22 of the jointing module 2 to joint the first object 3 and the second object 4 together. To separate the first object 3 and the second object 4, all the user needs to do is to lift controlling unit 141 of the prodding portion 14 to retract the snap-engagement balls 131 and the resilient engagement bodies 131′. FIG. 13 through FIG. 16 illustrate a usage state of the snap-engagement modules 1, 1′ of FIG. 1 and FIG. 2. Likewise, the usage state is applicable to the snap-engagement module 1″ of FIG. 7.

Referring to FIG. 17 through FIG. 20, there are shown schematic views 5-8 of the snap-engagement module according to the present invention. As shown in the diagrams, the snap-engagement modules 10, 10′, 10″ of FIG. 17 through FIG. 20 differ from the snap-engagement modules 1, 1′, 1″ of FIG. 1, FIG. 2, FIG. 7, and FIG. 8 in that the prodding unit 142 of the snap-engagement modules 10, 10′, 10″ of FIG. 17 through FIG. 20 has a plurality of recess units 143. Due to the recess units 143, the snap-engagement modules 10, 10′, 10″ of FIG. 17 through FIG. 20 operate in a way opposite to that of the snap-engagement modules 1, 1′, 1″ of FIG. 1, FIG. 2, FIG. 7, and FIG. 8. As soon as the user lifts the controlling unit 141, the controlling unit 141 drives the prodding unit 142 to move until the prodding unit 142 ends up between the snap-engagement balls 131 and between the resilient engagement bodies 131′. At this point in time, the prodding unit 142 protrudes the snap-engagement balls 131 and the resilient engagement bodies 131′, such that the snap-engagement balls 131 cannot retreat into the extension portion 12, thereby preventing the resilient engagement bodies 131′ from retracting and deforming. As soon as the user presses the controlling unit 141, the controlling unit 141 drives the prodding unit 142 to move until the recess units 143 of the prodding unit 142 end up between the snap-engagement balls 131 and between the resilient engagement bodies 131′ to thereby retract the snap-engagement balls 131 and the resilient engagement bodies 131′. As a result, the snap-engagement balls 131 retreat into the recess units 143, and in consequence the resilient engagement bodies 131′ retreat into the recess units 143.

Accordingly, the snap-engagement module and the jointing module of the present invention enable two objects to be jointed or separated quickly and conveniently.

The present invention is disclosed above by preferred embodiments. However, persons skilled in the art should understand that the preferred embodiments are illustrative of the present invention only, but should not be interpreted as restrictive of the scope of the present invention. Hence, all equivalent modifications and replacements made to the aforesaid embodiments should fall within the scope of the present invention. Accordingly, the legal protection for the present invention should be defined by the appended claims.

What is claimed is:

1. A snap-engagement module, comprising:
a fixing portion having a first jointing unit;
a support having a jointing hole, wherein the first jointing unit joining the jointing hole;
an extension portion connected to the first jointing unit, wherein a passage is formed inside the fixing portion and the extension portion;
a snap-engagement portion movably disposed at the extension portion; and
a prodding portion having a controlling unit and a prodding unit connected together, the controlling unit protruding from the fixing portion, the prodding unit being movably disposed at the passage and the snap-engagement portion to retract or protrude the snap-engagement portion.

2. The snap-engagement module of claim 1, wherein the extension portion has at least one opening, and the snap-engagement portion has at least one snap-engagement ball confined to the at least one opening, wherein the prodding unit is movably disposed at the snap-engagement ball to retract or protrude the snap-engagement ball.

3. The snap-engagement module of claim 2, further comprising a pointed or unpointed tapered aiming portion connected to the extension portion.

4. The snap-engagement module of claim 1, wherein the snap-engagement portion has at least one resilient engagement body connected to the extension portion, and the prodding unit is engaged with the resilient engagement body to retract or protrude the resilient engagement body.

5. The snap-engagement module of claim 1, further comprising a grip-and-turn body having a first prodding edge and a second prodding edge and pivotally connected to the controlling unit to form a pivotal point, such that the first prodding edge or the second prodding edge abuts against the fixing portion, and a distance between the pivotal point and the first prodding edge is different from a distance between the pivotal point and the second prodding edge.

6. The snap-engagement module of claim 1, further comprising a resilient element with an end abutting against a wall surface of the passage and another end abutting against the prodding unit.

7. The snap-engagement module of claim 1, wherein the controlling unit is T-shaped.

8. The snap-engagement module of claim 1, wherein the first jointing unit is press-in structure, a screwing structure, a fitting-extending structure, a soldering structure, a welding structure, an adhesive structure or a snap-engagement structure.

9. The snap-engagement module of claim 1, wherein the support is L-shaped.

10. The snap-engagement module of claim 1, wherein the support is made of metal.

11. The snap-engagement module of claim 1, wherein the support is made of plastic.

12. A jointing module jointed to the snap-engagement module of claim 1, the jointing module comprising:
a jointing base having a second jointing unit, at least one jointing hole, and a receiving space being in communication with the jointing hole; and
a jointing ring movably confined to the receiving space and centrally communicating with the jointing hole, wherein a snap-engagement portion of the snap-engagement module snap-engages the jointing ring.

13. The jointing module of claim 12, wherein the jointing ring is annular.

14. The jointing module of claim 12, wherein the receiving space has a round cross-sectional area.

15. The jointing module of claim 12, wherein the second jointing unit is one of a press-in structure, a screwing structure, a fitting-extending structure, a soldering structure, a welding structure, an adhesive structure, and a snap-engagement structure.

16. The jointing module of claim 12, wherein the second jointing unit is disposed at a periphery of the jointing hole.
